(19) United States
(12) Patent Application Publication
(10) Pub. No.: US 2002/0044156 A1
(43) Pub. Date: Apr. 18, 2002

(54) Computer apparatus, display apparatus, display control apparatus, storage medium, program transmission apparatus, and display control method

(75) Inventors: Yasunori Maezawa, Sagamihara-shi (JP); Hidetoshi Mori, Yamato-shi (JP); Keita Ishii, Yokohama-shi (JP); Masaru Saitoh, Yokohama-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation

(21) Appl. No.: 09/934,985

(22) Filed: Aug. 22, 2001

(30) Foreign Application Priority Data
Oct. 17, 2000 (JP) 2000-317133

(51) Int. Cl. G09G 5/00

(52) U.S. Cl. 345/698

(57) ABSTRACT

A computer apparatus, a display apparatus, a display control apparatus, a storage medium, a program transmission apparatus, and a display control method that enable visibility to be improved without decreasing ease of use, is provided for. By setting a viewport VP of a prescribed range with a mouse pointer MP as its center and changing a resolution of a display unit 12 when a user performs prescribed operations, an image within a range of the viewport VP is displayed in enlarged form in the entire area of a display area A of the display unit 12.

### BACKGROUND OF THE INVENTION

1. Field of the Invention

The present invention relates to a computer apparatus, a display apparatus, a display control apparatus, a storage medium, a program transmission apparatus, and a display control method, suitable for use in displaying images.

2. Description of the Related Art

The proliferation of liquid crystal display apparatuses using an LCD (Liquid Crystal Display) panel as a display unit for personal computers and various other kinds of monitors is well known. In recent years, in particular, technological advances have led to a dramatic improvement in the panel resolution of LCD panels. As a result, it has become possible to display an entire image (comprising many image objects and/or pixels) within the display area of an LCD panel, and to display many objects simultaneously on a display screen.

However, it is also well known that as panel resolution of a display unit increases, the size of the displayed objects decreases (e.g., objects such as characters and icons, displayed on the display screen) and the more difficult it is to vie such objects on the screen. This is an especially serious problem for users with weak eyesight.

Now, objects such as characters and icons, application windows, or the like, are laid out on the desktop on the basis of the operating system (abbreviated to “OS” below: for example, U.S. Microsoft Corporation's Windows® 95, Windows® 98, Windows® NT, etc.) of a computer apparatus.

It has traditionally been possible to set a desktop resolution on the display screen of a display unit in a plurality of steps. It has therefore been possible for a user to change a size of objects laid out on the desktop by changing the desktop resolution as desired.

However, when the desktop resolution is lowered in order to display objects at a greater size, it becomes impossible to display an entire desktop area in the display area of the display unit, or to display a plurality of objects simultaneously on the display screen. Moreover, when the desktop resolution is changed, processing is automatically executed by the OS in order for icons, application windows, and so forth, that reside on the desktop, to be rearranged on the desktop for which the desktop resolution has been changed. Thus, the layout of icons, application windows, and so forth, may be changed, inconveniencing the user. Also, when the desktop resolution is changed, display unit and display unit driver reboot processing, at least, may be performed on the OS side, depending on the kind of OS, giving the user a feeling of lack of continuity in using the computer apparatus. Thus, changing the desktop resolution in this way cannot be called a fundamental solution to the problem.

A function called screen expansion already exists for this kind of problem. When, for example, an image 640×480 dots in size is displayed on a display unit with the panel resolution set to 1024×768 dots, this function displays the image, only, enlarged by a prescribed magnification. By this means, characters and icons can be displayed in enlarged form, improving their visibility to the user.

However, as this function simply enlarges the entire image, various kinds of inconveniences may arise: for example, after enlargement, a part that the user desires to be at the edge of the display screen may not be and may be difficult to see, or may be outside the display area of the display screen, and, if so, not visible at all.

### SUMMARY OF THE INVENTION

It is an objective of the present invention to provide a computer apparatus, display apparatus, display control apparatus, storage medium, program transmission apparatus, and display control method that enable visibility to be improved without decreasing ease of use.

In one aspect of the present invention, when a prescribed event is generated, the image being displayed on the display unit is displayed with a changed display unit display resolution. By changing the display resolution of the display unit in this way, the screen being displayed on the display unit can be displayed in enlarged or reduced form. As a result, there is no intention of limiting the case to either screen enlargement or reduction, but to give a concrete example of screen enlargement, by lowering the display resolution of the display unit, it is possible to perform enlarged display of part of the screen being displayed on the display.

In another aspect of the present invention, it is desirable to store, by display status storage means, the display status of the display unit when the prescribed event occurred—that is, the original display status before performing enlarged or reduced screen display. The display status of the display unit includes the desktop resolution of the display unit, the data of the screen that was being displayed when the prescribed event occurred, and so on. Moreover, if data of the screen to be drawn anew on the display unit is stored by display status storage means when it is output from the computer main unit, the screen data can be updated and the latest screen data can be held at all times. The screen to be displayed by the display unit can be either a still image or a moving image.

Further, a prescribed event generated by event generating means can be characterized by being input to the display control means without being notified to the operating system. By so doing, it is possible for screen enlargement or reduction processing to be executed by changing the display resolution of the display unit without notifying the OS.

In another aspect of the present invention, when prescribed input is performed while a screen is being displayed at the desktop resolution set by the desktop resolution setting section, the image is displayed with the display unit display resolution made different from the desktop resolution. Therefore, it is possible to perform enlarged or reduced display of an image that was originally displayed at the desktop resolution.

Additionally, if a prescribed input is performed while a screen is being displayed at a display resolution different from the desktop resolution, as described above, the image is displayed at a display resolution that has been made the same as the desktop resolution, it is possible to restore the original desktop screen—that is, the display prior to enlargement or reduction.

In another aspect of the present invention, when screen enlargement processing is requested by the interface driver, the display status of the display apparatus main unit is stored by display status storage means, and the image within the area set by area setting means can be displayed in enlarged form on the display apparatus main unit for which the display resolution has been lowered by enlargement processing means.

Additionally, the area setting means can be characterized as setting a prescribed area on the basis of a pointer displayed on the screen of the display apparatus main unit. As a result, the user can set an area at the desired position. Also, it is desirable for the size of the area set by the area setting means to be selectable. This makes it possible to change the screen enlargement magnification. In addition to the mouse pointer (mouse cursor), the cursor indicating the input position of a character, etc., or the like, can also be used as a pointer.

The display control apparatus of the present invention acquires image data of an area set on the basis of the pointer position, and displays this image data on the display apparatus for which the display mode has been changed. In this way, the image display magnification can be changed. Additionally, when the acquired image data is displayed on the display apparatus, this display control apparatus stores the display status of the screen that was being displayed on this display apparatus. Here, “display status of the screen” includes, at least, the desktop resolution (display resolution of the display unit) at that time, and may also include the data for displaying the screen at that time, and so forth.

Also, when the pointer reaches the edge of a screen displayed at a changed magnification, this display control apparatus may also scroll the screen by means of scrolling means.

In another aspect of the present invention, the present invention can also be utilized as a storage medium on which a program that executes first processing that accepts input for changing the screen display resolution, and second processing that displays part of the on-screen image being displayed when the first processing is executed, with the display resolution of the display screen changed, is stored, so as to be readable by a computer apparatus.

In another aspect of the present invention, the present invention can also be taken as a program transmission apparatus including: storage means for storing a program to be executed on a computer apparatus; and transmitting means for reading the program from the storage means and transmitting this program to the computer apparatus, in which the above described program executes on the computer apparatus processing that, when prescribed input requesting image enlargement processing is performed, saves the desktop environment and image data of the display screen at that time and performs enlarged display of the image within an area set in part of the display area of that display screen; and processing that updates the saved image data when image data to be displayed on the display screen is input anew.

It will become apparent to those of ordinary skill in the art that the computer apparatus here is not limited to a computer apparatus solely consisting of a display unit and a computer main unit that controls it, but is also inclusive of devices, systems, equipment and similar apparatuses that include a display apparatus, a driver that controls the display unit, and so forth.

Additionally, the display control method of the present invention may further comprise: a first step of setting an area in part of the image being displayed when input is performed for changing that image size; a second step of changing the display mode of the display apparatus without notifying the operating system; and a third step of displaying on the display apparatus for which the display mode has been changed, the image within the area set by the first step.

Further, the display control method of the present invention may also comprise: a fourth step whereby, when input is performed for restoring the image size to what it was originally, the display mode of the display apparatus, which was changed by the second step, is restored to what it was originally; and a fifth step of displaying an image on the display apparatus for which the display mode has been restored to what it was originally.

### BRIEF DESCRIPTION OF THE DRAWINGS

Other aspects, features, and advantages of the present invention will become more fully apparent from the following detailed description, the appended claims, and the accompanying drawings in which:

FIG. 1 is a drawing showing a configuration of a computer apparatus according to one embodiment of the present invention;

FIG. 2 is a drawing showing an example of an operating section of a computer apparatus;

FIG. 3 is a drawing showing a viewport that is set based on a mouse pointer displayed on a display screen of a display unit, and a situation when this viewport is displayed in enlarged form;

FIG. 4 is a drawing showing a configuration for performing enlarged display of a viewport;

FIG. 5 is a table showing a relationship between a viewport size, a panel resolution, and an enlargement magnification of an image displayed in a viewport;

FIG. 6 is a drawing showing examples of an image displayed in enlarged form;

FIG. 7 shows an example of a program for executing processing for performing enlarged display of a viewport according to a display area of a display unit;

FIG. 8 is a drawing showing a flow when viewport enlargement processing is performed;

FIG. 9 is a drawing showing a processing flow when a display range is scrolled in accordance with a movement of the mouse pointer in a viewport displayed in enlarged form;

FIG. 10 is a drawing showing a processing flow when a viewport displayed in enlarged form is restored to its original display status; and

FIG. 11 is a drawing showing another example in which a viewport is displayed in enlarged form.

### DETAILED DESCRIPTION

In a preferred embodiment of the present invention, a computer apparatus that sets a viewport area on a display screen displayed on a display unit, and performs enlarged display of the image within the viewport area when a prescribed operation is performed by the user is provided for, wherein, in order to perform enlarged image display at this time, the display resolution of the display unit, not the desktop resolution, is changed.

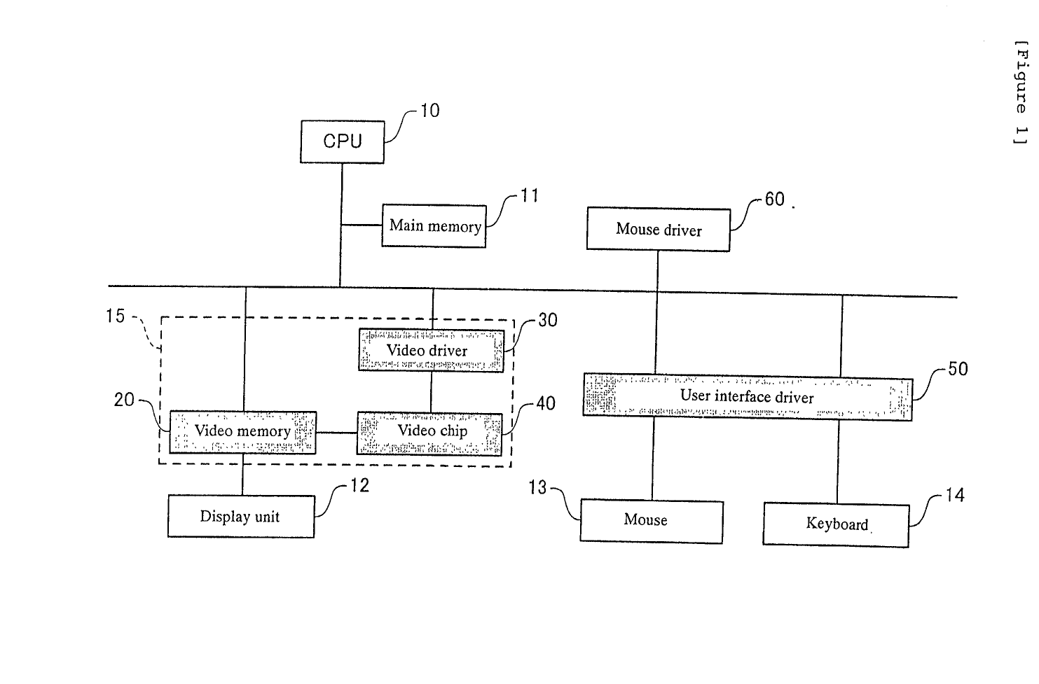

FIG. 1 is a drawing to explain the general configuration of the computer apparatus according to a preferred embodiment. In this drawing, reference numeral 10 denotes the CPU on the computer main unit side that administers the entire computer apparatus and is controlled on the basis of the OS, reference numeral 11 denotes the main memory on the computer main unit side, reference numeral 12 denotes a display unit (display apparatus main unit), reference numeral 13 denotes a mouse or other manipulating means (called simply “mouse” below) for manipulating a mouse pointer (pointer) displayed on the display screen of the display unit 12, and reference numeral 14 denotes a keyboard.

In a preferred embodiment, an LCD panel is used for the display unit 12. In order to perform screen display on the display unit 12 based on drawing instructions from the CPU 10, the computer apparatus is provided with a display control block (display control means) 15.

The display control block 15 comprises video memory 20 that stores image data transferred from the main memory 11, etc., a video driver (display apparatus driver) 30 that performs control for displaying screens on the display unit 12, and a video chip (display control section, image display means) 40 that executes prescribed processing on the basis of commands from the video driver 30.

The mouse 13 and keyboard 14 are provided with a user interface driver 50 that processes events when the user manipulates the mouse 13 or keyboard 14. Also, the mouse 13 is provided with a mouse driver 60 that converts a user event input via the user interface driver 50 to prescribed processing corresponding to an application in the active state, and executes it.

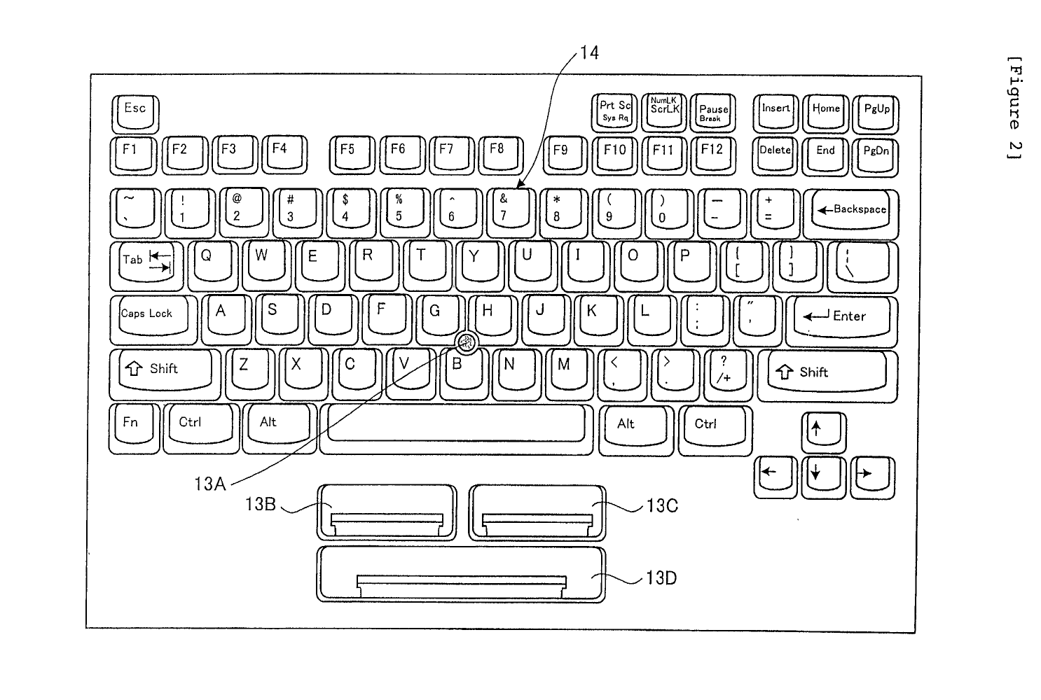

FIG. 2 shows an example of the operating section of the computer apparatus. The computer apparatus according to the present embodiment is of notebook type, and its operating section comprises a keyboard 14, and in addition a pointing device 13A and operating buttons 13B, 13C, and 13D, as the mouse 13 shown in FIG. 1.

The pointing device 13A is equipped with a detection sensor (not shown) at its base, and operations to move the mouse pointer on the display screen of the display unit 12 are performed by detecting displacement of the pointing device 13A in any direction with this detection sensor. Operating buttons 13B and 13C are for performing so-called click operations, while operating button 13D allows an action to be defined without relation to the OS. When operating button 13D is manipulated, a request for viewport enlargement processing, described later, is made to the user interface driver 50.

In a computer apparatus with this kind of configuration, the resolution of the desktop displayed on the display unit 12 as the basic screen (called simply “desktop resolution” below) is stored by storage means (a desktop resolution setting section) such as the main memory 11 or other nonvolatile memory, for example. It is possible to select a plurality of steps for this desktop resolution, apart from the default desktop resolution, with the panel resolution of the display unit 12 itself as the maximum value.

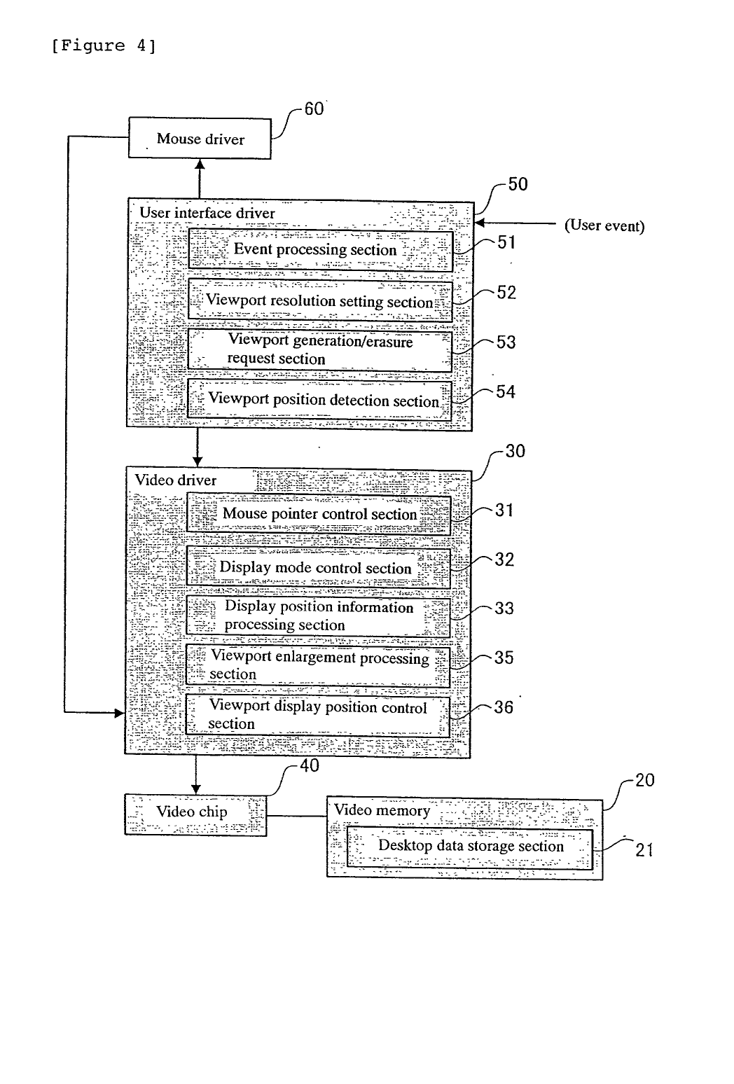

Data of the screen to be displayed based on drawing instructions from the CPU 10 is transferred from the main memory 11 to the video memory 20, and is stored in a desktop data storage section (display status storage means) 21 set in the video memory 20 (see FIG. 4). The desktop resolution and the displayed image data are stored in this desktop data storage section 21 as the display status or desktop environment of the display unit 12. Image data updating is performed constantly for the desktop data storage section 21 from the CPU 10 side.

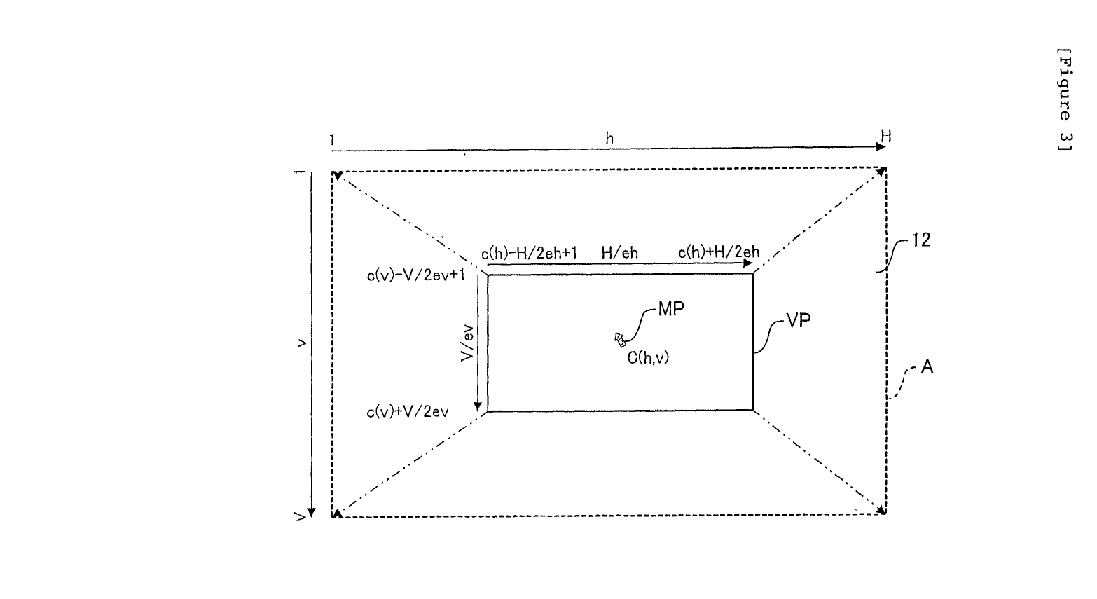

A mouse pointer MP is displayed by the video driver 30 on the display screen of the display unit 12, as shown in FIG. 3. When the user performs an operation to move the mouse pointer MP on the display screen of the display unit 12 by means of the mouse 13 (pointing device 13A), an event corresponding to that operation is input to the video driver 30 via the user interface driver 50 and the mouse driver 60. Then, predetermined processing is executed by the video chip 40 on the basis of a command by a mouse pointer control section (pointer position recognition means) 31 provided in the video driver 30 (see FIG. 4), and by this means the mouse pointer MP moves on the display screen of the display unit 12.

The functional configuration of the display control block 15 of the computer apparatus in realizing the present invention in a computer apparatus with the above described kind of hardware configuration is as follows.

Namely, the user interface driver 50 of the display control block 15 is provided with an event processing section (event generating means) 51, as shown in FIG. 4. This event processing section 51 outputs events corresponding to operations performed by the user with the mouse 13 or keyboard 14.

Also, as shown in FIG. 3, the user interface driver 50 comprises a viewport resolution setting section (display resolution setting section) 52, viewport generation/erasure request section 53, and viewport position detection section (area setting means) 54, for displaying a viewport (area) VP of a prescribed size on the display screen of the display unit 12.

The viewport VP is set as a prescribed area based on the mouse pointer MP displayed on the display screen of the display unit 12, and in the present embodiment, is set, for example, as a rectangular area with the mouse pointer MP at its center.

The size of this viewport VP can be set by the viewport resolution setting section 52 in a plurality of steps within a range with the panel resolution of the display unit 12 as the maximum value. For example, if the panel resolution of the display unit 12 is 1600×1200 pixels (UXGA), the size of the viewport VP could be set at five levels: 1400×1050 dots (SXGA+), 1280×1024 dots (SXGA), 1024×768 dots (XGA), 800×600 dots (SVGA), and 640×480 dots (VGA). The user selects the desired viewport VP size from the plurality of levels that can be set, and inputs this using a predetermined operating method. By this means, the selected viewport VP size is set in the viewport resolution setting section 52.

On receiving notification of an event for requesting viewport VP enlarged display from the event processing section 51, the viewport generation/erasure request section 53 issues a request for viewport VP generation to the video driver 30. Also, on receiving notification of an event for requesting cessation of viewport VP enlarged display from the event processing section 51 while the viewport VP is being generated, the viewport generation/erasure request section 53 issues a request to the video driver 30 for processing to stop the viewport VP enlarged display and restore the original desktop display.

The viewport position detection section 54 calculates the position at which the viewport VP should be generated at the point in time at which viewport VP generation is requested by the viewport generation/erasure request section 53. By this means, in the present embodiment, information on the position at which the viewport VP should be generated (more specifically, the positions of three or four of the corners of the viewport VP) is acquired based on the position of the mouse pointer MP that can be recognized by the mouse pointer control section 31 at that point in time, and this is output.

The video driver 30 that receives viewport VP generation requests from the viewport generation/erasure request section 53 comprises, as the corresponding configuration, a display mode control section (display mode changing means) 32, a display position information processing section 33, a viewport enlargement processing section (enlargement processing means, image data acquisition means) 35, and a viewport display position control section (scrolling means) 36.

On receiving a viewport VP generation request from the viewport generation/erasure request section 53, the display mode control section 32 changes the display mode—that is, the display resolution—of the display unit 12 according to the viewport VP size set in the viewport resolution setting section 52. For example, if the viewport VP size is set as 800×600 dots, the display mode control section 32 sets the display resolution of the display unit 12 to 800×600 dots.

The display position information processing section 33 converts position information for the viewport VP to be generated, that is output from the viewport position detection section 54, to position information in the image data stored in the desktop data storage section 21 of the video memory 20, and stores this in a register area set in the video chip 40.

As image data acquisition means, the viewport enlargement processing section 35 has the video chip 40 acquire from the desktop data storage section 21 image data of the part corresponding to the viewport VP area to be generated, based on the above described position information stored in the register area of the video chip 40, and has it displayed on the display unit 12 for which the display resolution has been changed by the display mode control section 32. In parallel with this, the viewport enlargement processing section requests the video chip 40 to perform processing to enlarge the image size for image data stored in the desktop data storage section 21 up to the panel resolution of the display unit 12.

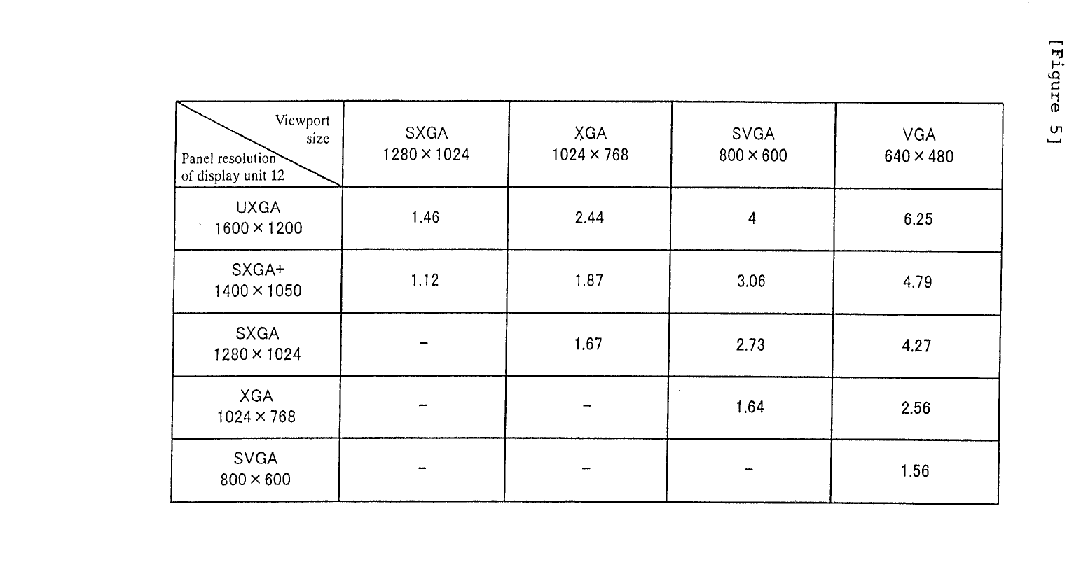

Since, in the present embodiment, the display resolution of the display unit 12 is here made the same as the viewport VP size by the display mode control section 32, the image in the area within the viewport VP is enlarged to the same size as display area A of the display unit 12 (the area enclosed by dotted lines in FIG. 3), and is displayed in the entire area of display area A of the display unit 12. Thus, the image in the area within the viewport VP is displayed enlarged to the prescribed magnification. The table shown in FIG. 5 shows the enlargement magnifications for viewport VP sizes (=display unit 12 display resolution after enlargement processing) corresponding to various display unit 12 panel resolutions. For example, a viewport VP of 800×600 dots displayed on a display unit 12 with an original panel resolution of 1600×1200 dots is displayed in enlarged form in the entire display area of the display unit 12, being enlarged to a magnification of 4×.

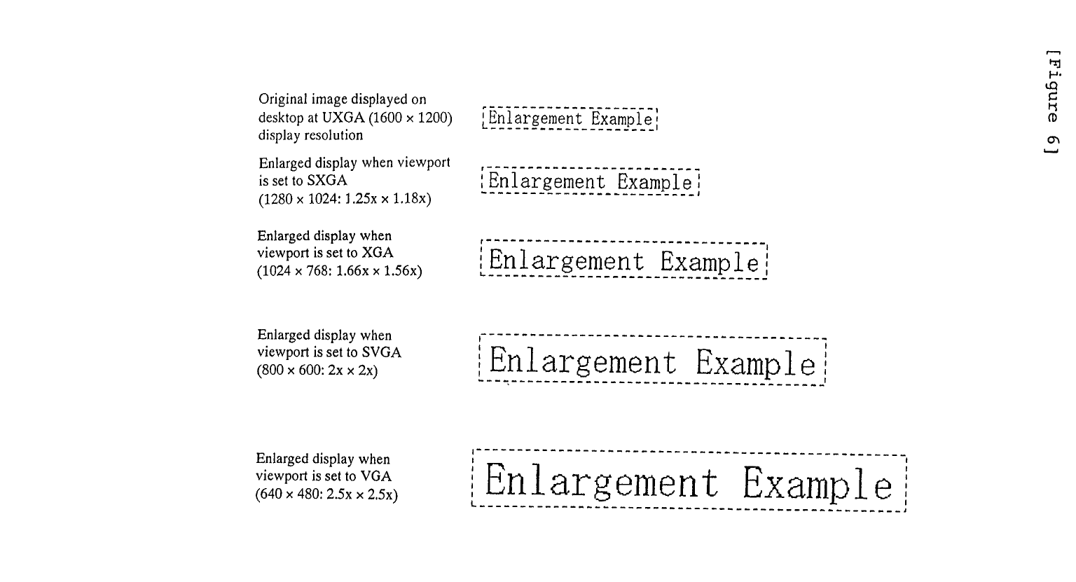

FIG. 6 shows examples of an image enlarged by the viewport enlargement processing section 35. The sample images shown have been enlarged for display by setting the viewport VP to 1280×1024, 1024×768, 800×600, and 640×480 dots, respectively, for the original image displayed on the display unit 12 with a panel resolution of 1600×1200 dots, and changing the display resolution of the display unit 12.

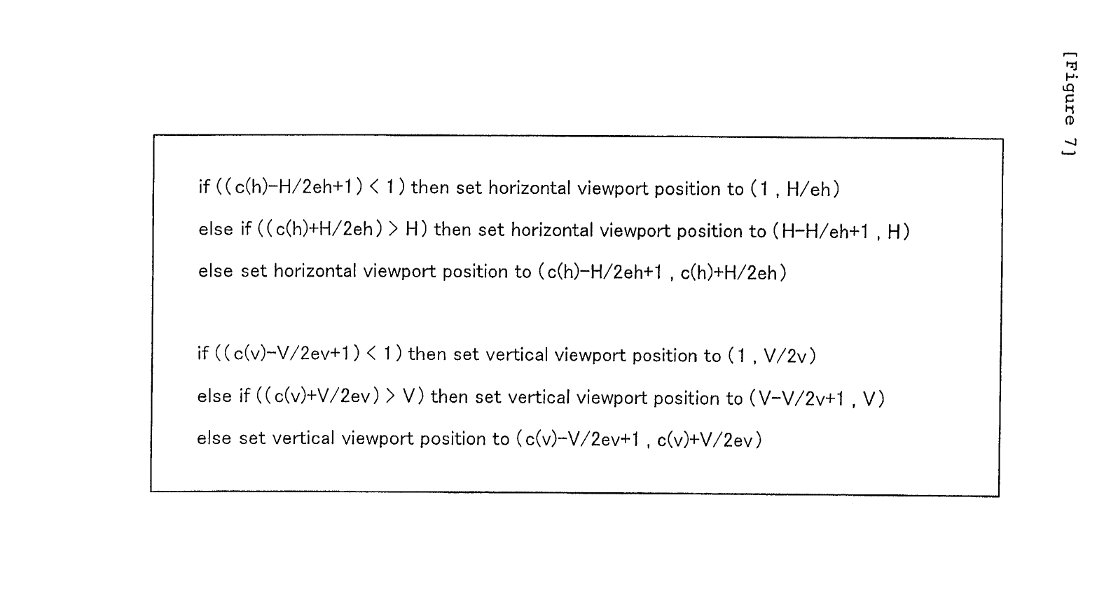

At the time of performing enlarged display of the viewport VP, the viewport enlargement processing section 35 performs processing to make it match the display area of the display unit 12. FIG. 7 shows an example of a program for this purpose. This program acquires the coordinates of four points—two in the horizontal direction and two in the vertical direction—for the viewport VP shown in FIG. 3, and executes processing to position these at the four corners (whose coordinates are already known) of the display area of the display unit 12. To be more precise, when the mouse pointer MP position coordinates C in FIG. 3 are (h, v), processing is performed so that the horizontal coordinates of the two points at both horizontal-direction corners of the viewport VP, [c(h)−H/2eh+1] and [c(h)+H/2eh], are set to (1, H/eh) and (H−H/eh+1, H), and the vertical coordinates of the two points at both vertical-direction corners of the viewport VP, [c(v)−V/2ev+1] and [c(v)+V/2ev], are set to (1, V/2v) and (V−V/2v+1, V).

As a result, the viewport VP is displayed in enlarged form, with the part desired by the user at the center, in the entire display area of the display unit 12 with the mouse pointer MP at the center.

At the time of performing viewport VP enlargement processing as described above, the viewport enlargement processing section 35 does not reset (clear) the original display status data stored in the desktop data storage section 21. Original display status data includes the desktop resolution and image data for the image that was being displayed on the desktop (that is, the desktop, and icons, application windows, etc., displayed on the desktop), where such continue to be held in the desktop data storage section 21.

That is to say, the OS is not affected by viewport VP enlargement processing.

In a viewport VP displayed in enlarged form on the display screen of the display unit 12, the mouse pointer MP is under the control of the video driver 30, and can be moved in the same way as on the desktop.

The viewport display position control section 36 monitors movement of the mouse pointer MP on this viewport VP. In the same way as a so-called virtual screen function, on detecting that the mouse pointer MP has reached the edge of the viewport VP area and an attempt is being made to move it further, outside the area, the viewport display position control section 36 moves the position of the viewport VP in the direction of movement of the mouse pointer MP, and scrolling of the image displayed within the viewport VP area can be performed. Also, on detecting that the position of the viewport VP has reached the edge of the desktop area, the viewport display position control section 36 halts viewport VP movement processing—that is, scrolling.

Next, the viewport VP enlargement processing method in a computer apparatus with the above described kind of configuration will be described.

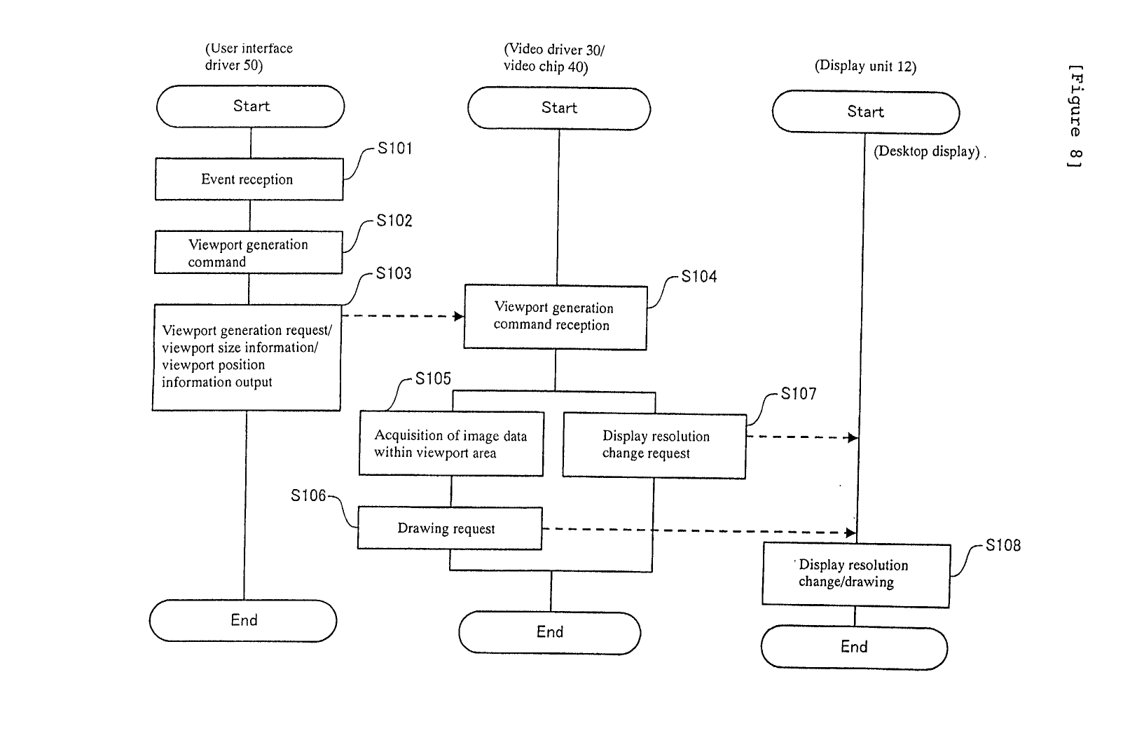

FIG. 8 shows the flow when viewport VP enlargement processing is performed. As shown in this drawing, when the user presses operating button 13D after positioning the mouse cursor with the pointing device 13A as a mouse 13 in the center of the position for which enlarged display is desired, that event is received by the event processing section 51 of the user interface driver 50 (step S101).

A viewport generation command is then output to the viewport generation/erasure request section 53 from the event processing section 51 (step S102). On receiving this, the viewport generation/erasure request section 53 issues a viewport generation request to the video driver 30. At this time the user interface driver 50 outputs to the video driver 30 viewport information on the size of the viewport VP to be generated, which has been set in the viewport resolution setting section 52. Together with this, the user interface driver 50 outputs to the video driver 30 viewport VP position information based (centered) on the mouse pointer MP at that point in time, detected by the viewport position detection section 54 (step S103).

The size of the viewport VP can be determined by the user beforehand with the viewport resolution setting section 52, or it is also possible to have a plurality of selectable viewport VP sizes and enlargement magnifications indicated to the user by the user interface driver 50 when a viewport generation request is received from the user, and to have the user make a selection and decision from among these.

The video driver 30 receives a request from the viewport generation/erasure request section 53 (step S104). The video driver 30 then converts viewport VP position information output from the viewport position detection section 54 to position information in the video memory 20 by means of the display position information processing section 33, and stores it in the register area of the video chip 40. Also, the viewport enlargement processing section 35 has the video chip 40 acquire from the desktop data storage section 21 image data within the area of the viewport VP to be generated, based on the above described position information (step S105).

The video chip 40 executes processing by the program shown in FIG. 7, based on the viewport VP position coordinates, for the image data within the acquired viewport VP area, and then issues a drawing request to the display unit 12 (step S106).

The display mode control section 32 issues a request to the video chip 40 for display unit 12 display resolution change processing on the basis of viewport VP size (resolution) information output from the viewport resolution setting section 52 (step S107). On receiving this, the video chip 40 stores the viewport VP size information (set values) in the register area, and changes the display resolution of the display unit 12.

In addition, the video chip 40 has drawing executed by the display unit 12 for which the display resolution has been changed, based on image data acquired from the desktop data storage section 21 (step S108).

Together with this, the video chip 40 executes processing to enlarge the image size for image data stored in the desktop data storage section 21 up to the panel resolution of the display unit 12, in accordance with a request from the viewport enlargement processing section 35.

In this way, the image data within the viewport VP area is displayed in enlarged form in the entire display area of the display unit 12 for which the display resolution has been changed.

As the image size for this image data stored in the desktop data storage section 21 undergoes enlargement processing up to the panel resolution of the display unit 12, the entire desktop area can be held as a so-called virtual screen.

While the viewport VP is displayed in enlarged form on the display unit 12, the viewport enlargement processing section 35 acquires image data from the desktop data storage section 21 which receives image data updates from the CPU 10 side. In this way, it is possible for the image displayed in enlarged form on the display unit 12 to be updated and displayed in the same way as on the desktop, and also for moving pictures to be displayed.

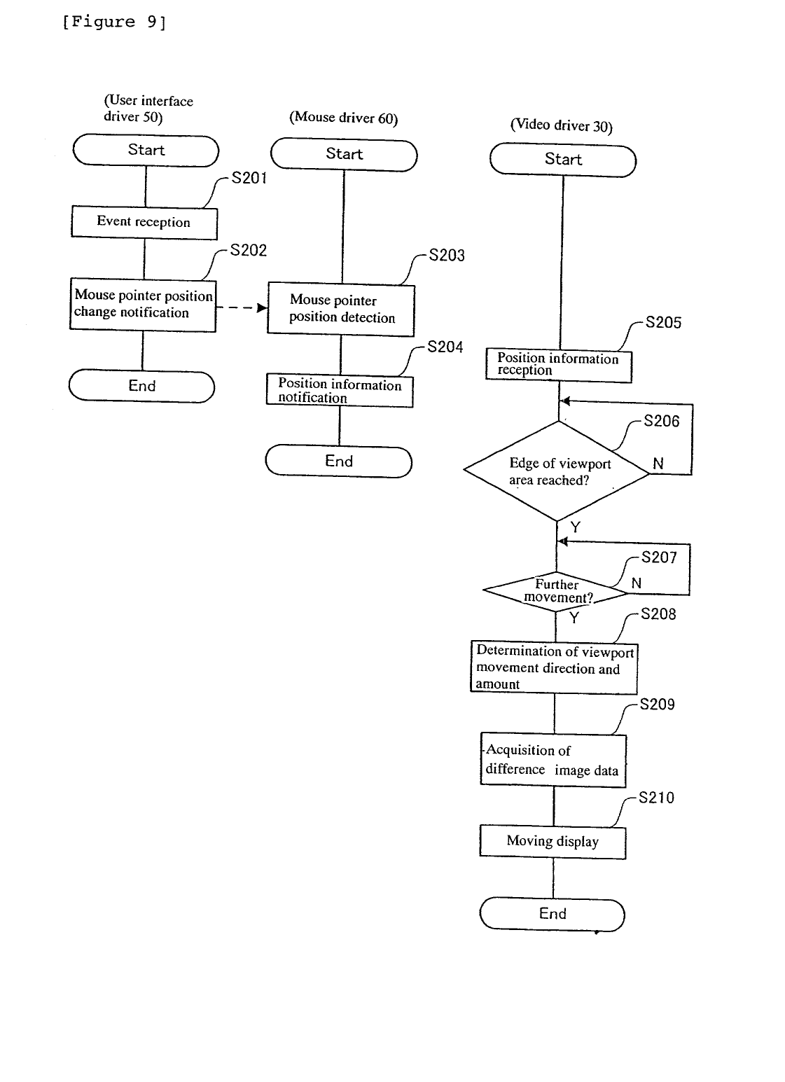

FIG. 9 shows the flow of screen scroll processing when the mouse pointer MP is manipulated while the viewport VP is being displayed in enlarged form. When the mouse pointer MP is manipulated by means of the pointing device 13A while the viewport VP is being displayed in enlarged form, the event processing section 51 of the user interface driver 50 detecting this receives this event (step S201). The event processing section 51 then notifies the mouse driver 60 on the OS side that there has been an operation to change the position of the mouse pointer MP (step S202).

The mouse driver 60 detects the position of the mouse pointer MP (step S203), and notifies that position information to the video driver 30 (step S204).

On receiving notification from the mouse driver 60 (step S205), the video driver 30 analyzes, in the viewport display position control section 36, whether or not the mouse pointer MP has reached the edge of the viewport VP area and an attempt is being made to move it further, outside the area (steps S206 and S207). Then, when it is detected that the mouse pointer MP has reached the edge of the viewport VP area and an attempt is being made to move it further, outside the area, the position of the viewport VP on the virtual screen is moved.

At this time the viewport display position control section 36 determines the direction and amount of movement of the viewport VP (step S208), and based on this, acquires the image data of the area to be displayed from the desktop data storage section 21 of the video memory 20 (step S209). The viewport VP display range is shifted and scrolling is carried out by performing viewport VP display based on this data (step S210).

On detecting that the position of the viewport VP has reached the edge of the desktop area, the viewport display position control section 36 halts viewport VP movement processing.

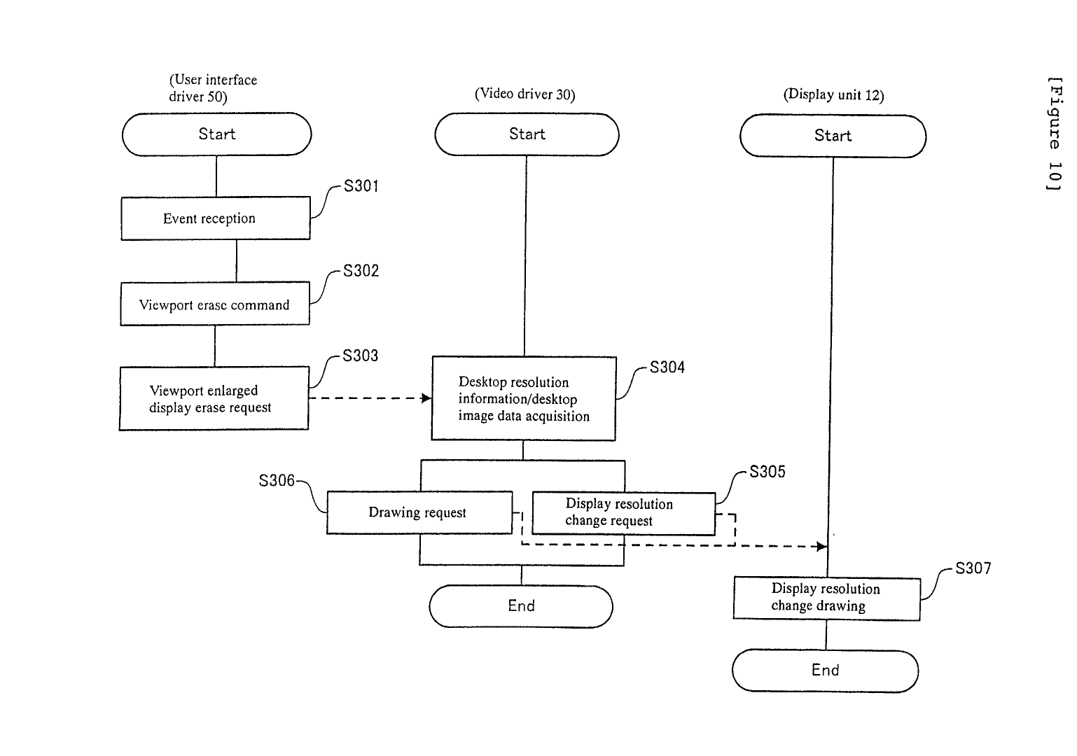

Next, the processing for halting enlarged display, when enlarged display is being performed with the viewport VP as described above, will be described with reference to FIG. 10.

As shown in FIG. 10, when the user presses operating button 13D while enlarged viewport VP display is being performed, that event is received by the event processing section 51 of the user interface driver 50 (step S301). A viewport erase command is then output to the viewport generation/erasure request section 53 from the event processing section 51 (step S302). On receiving this, the viewport generation/erasure request section 53 issues a request to the video driver 30 to erase the enlarged viewport VP display (step S303).

On receiving this, the video driver 30 acquires the original display status data—that is, the desktop resolution and image data—stored in the desktop data storage section 21 of the video memory 20 (step S304). Then, the display mode control section 32 of the video driver 30 issues a request to the video chip 40 for processing to change the display mode—that is, the display resolution—of the display unit 12 (step S305). Together with this, the video driver 30 issues a request to the video chip 40 for drawing processing based on the original display status data acquired from the desktop data storage section 21 (step S306).

On receiving this, the video chip 40 changes the display resolution of the display unit 12 and has the image drawn at the original desktop resolution (step S307). By this means, the state before enlarged display of the viewport VP was performed is restored. Since the original desktop resolution and image data are held in the desktop data storage section 21 while enlarged viewport VP display is being performed, speedy processing can be performed at this time. Also, as image data is constantly updated in the desktop data storage section 21, display can be performed based on the latest image data.

With the computer apparatus of the present embodiment, as described above, when the user performs a prescribed operation a viewport VP of a prescribed range with the mouse pointer MP at its center is set, and the image within this viewport VP range is displayed in enlarged form in the entire display area of the display unit 12. Thus, while operating the computer apparatus, the user can perform enlarged display of the image in a desired area—to be more precise, on-screen objects such as characters and icons—whenever he or she wishes. It therefore becomes possible to display a large desktop on the display unit 12, which has high resolution, to display an entire image of large size (comprising many dots) within the display area of the display unit 12, and to perform enlarged viewport VP display only when necessary without losing the advantage of being able to view a plurality of objects on the screen. As a result, it is possible to prevent a decrease in display unit 12 visibility, which can be said to be especially advantageous for users with weak eyesight.

Also, with this kind of computer apparatus, by using a display unit 12 with high resolution it is possible to provide a large desktop without a concomitant decrease in visibility even while aiming at a reduction in the size of the display unit 12.

In addition, when enlarged viewport VP display is performed, the display resolution of the display unit 12 is changed by the display mode control section 32 of the video driver 30 without changing the desktop resolution. As a result, it is possible to perform so-called on-the-fly enlarged image display that does not require reset processing for the display unit 12, enabling seamless operation to be ensured for the user. Moreover, since applications that are dependent on the desktop resolution are not affected, and the layout of icons, application windows, and so forth, displayed on the desktop does not change, there is no degradation of ease of use for the user.

Furthermore, image enlargement processing and virtual screen generation in accordance with viewport VP settings are performed only by the user interface driver 50, video driver 30, video chip 40, and video memory 20 of the display control block 15, and are not notified to the OS or application side, and, so to speak, constitute local processing of the display control block 15 only. Therefore, the OS and applications are not affected in any way by image enlargement processing.

Also, as a viewport VP with the mouse pointer MP set as its center is displayed in enlarged form in the entire display area of the display unit 12, the user can perform enlargement processing centered on the desired part. It is therefore possible to prevent situations where, for example, after enlargement, a part that the user wants is at the edge of the display area and difficult to see, or is outside the display area and so not visible at all.

Moreover, operations can be performed to move the mouse pointer MP in the viewport VP, and furthermore the viewport VP enlarged display area scrolls if the mouse pointer MP reaches the edge of the viewport VP display area, providing excellent operability.

In addition, desktop (and application) image data is saved in the desktop data storage section 21 while enlarged viewport VP display is being performed, and moreover data updating is performed constantly from the CPU 10 side. Therefore, the latest image can always be displayed on both the viewport VP enlarged display screen and the original-status screen displayed when enlarged viewport VP display is halted. Also, since the CPU 10 performs image data updating for the desktop data storage section 21, various operations can be executed on the desktop and in applications even during enlarged viewport VP display.

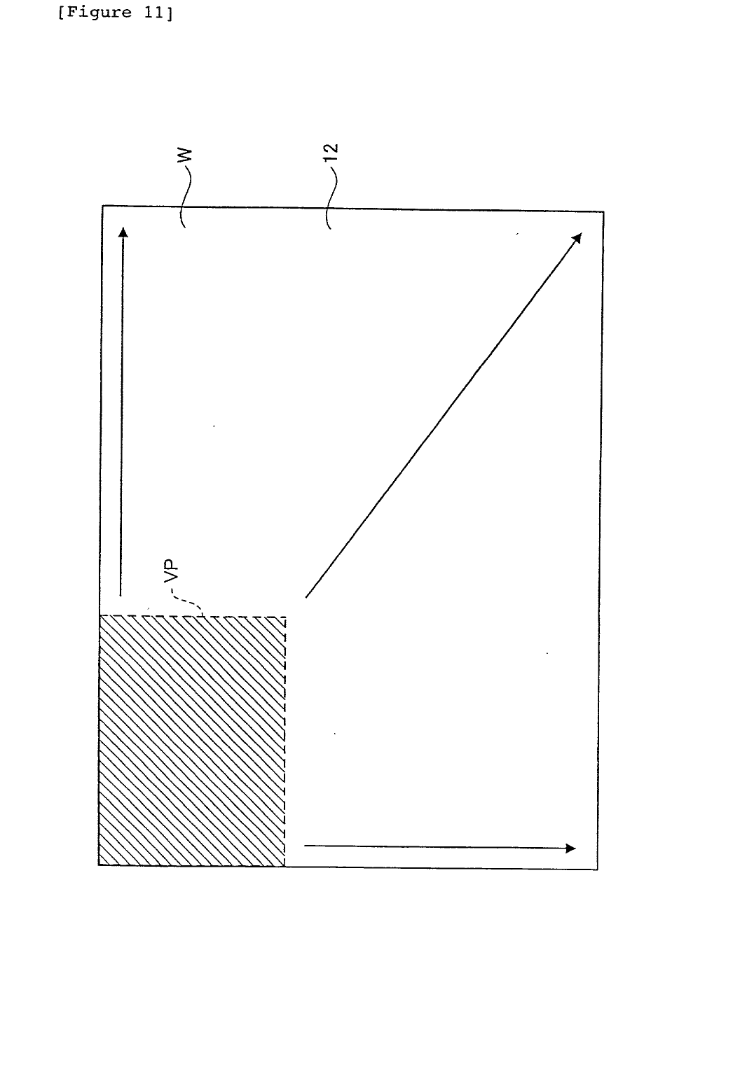

In the above described embodiment, the configuration is such that enlarged display of the viewport VP is performed based on the mouse pointer MP, but this is not a limitation. For example, it would also be possible to perform enlarged display of the window W in the active state on the desktop when a predetermined operation is performed, as shown in FIG. 11. In this case, instead of using the mouse pointer MP as a base, a viewport VP could be set automatically in, for example, the top-left corner of the active window W, and enlarged to fill the entire display area of the display unit 12.

Apart from this, the cursor for character input, for example, could be considered as the base instead of the mouse pointer MP. In this case, however, it is necessary to acquire cursor position information, etc., from an application on the OS side, making it impossible to perform processing independently of the OS as in the above described embodiment.

Also, in the above described embodiment, the position of the outer frame of the viewport VP that is set on the basis of the mouse pointer MP when the desktop screen is being displayed can be displayed together with the mouse pointer MP.

Further, in the above described embodiment the display unit 12 is not limited to an LCD, but can also be of another type, such as a CRT (Cathode Ray Tube).

Also, the example of a so-called notebook computer is given for the computer apparatus, but a desktop type, etc., can also be used. Of course, the mouse 13 is not limited to a pointing device 13A and operating buttons 13B, 13C, and 13D, and various other kinds can be used as well as an ordinary mouse.

Moreover, in the above described embodiment, an approach is taken whereby enlarged display of the viewport VP and restoration of the original display status are performed by changing the display resolution of the display unit 12 with respect to the panel resolution of the display unit 12, but an approach is also possible whereby, starting from an initial state in which the desktop resolution set in the display unit 12 and the display resolution of the display unit 12 are the same, the display resolution of the display unit 12 is made to differ from the desktop resolution. At the same time, an approach is also possible whereby the image display status can be restored to its original form by restoring the display unit 12 display resolution to what it was originally—that is, by making it the same as the desktop resolution.

In the present embodiment, it is also possible for a program that performs the kind of processing shown in the above described embodiment to be stored in a storage medium such as any of various kinds of memory chip, and for the program stored in this storage medium to be executed by a computer apparatus.

Moreover, the present embodiment can also take the form of a program transmission apparatus, etc., comprising storage means such as CD-ROM, DVD, memory, hard disk, RAM, etc., storing a program that performs the kind of processing shown in the above described embodiment; and transmitting means for reading the program from this storage means and transmitting the program to an apparatus that executes the program, via a connector or a network such as the Internet, a LAN, or the like. Such a program transmission apparatus is especially suitable when installing a program that performs the above described kind of processing for updating the program for an existing display unit driver.

The computer apparatus here includes a computer apparatus consisting of a display unit and a computer main unit that controls it, but the invention is not so limited, as one of ordinary skill in the art would well understand that the apparatus is also inclusive of devices having a display apparatus, a driver unit that controls the display unit, and so forth.

In addition to the above, it is possible to selectively adopt or reject the configuration presented in the above described embodiment, or change it to another configuration as appropriate, insofar as this does not deviate from the essentials of the present invention.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1) A computer apparatus, comprising:
a display unit;
a computer main unit that is controlled by an operating system and outputs drawing instructions to said display unit;
an event generator for accepting operations by a user and generating events; and
a display unit control logic for displaying a screen being displayed on said display unit, with a display resolution of said display unit changed, when a prescribed event is generated by said event generator.

2) The apparatus according to claim 1, wherein said display unit control logic further comprises a display status storage section for storing a display status of said display unit when a prescribed event is generated by said event generator.

3) The apparatus according to claim 2, wherein, when screen data to be newly drawn by said display unit is output from said computer main unit, said display unit control logic stores said data in said display status storage section.

4) The apparatus according to claim 1, wherein a prescribed event generated by said event generator is input to said display unit control logic without being notified to said operating system.

5) A computer apparatus, comprising:
a display unit;
a desktop resolution setting section for setting a desktop resolution for display by said display unit;
a display resolution setting section for setting a display resolution of said display unit; and
a display control section for displaying images on said display unit,
wherein, when prescribed input is performed while an image is displayed at said desktop resolution set by said desktop resolution setting section, said display resolution setting section makes the display resolution of said display unit different from said desktop resolution, and
said display control section displays said image on said display unit for which said display resolution has been set as different from said desktop resolution.

6) The apparatus according to claim 5,
wherein when prescribed input is performed while an image is displayed at said display resolution differing from said desktop resolution, said display resolution setting section makes that display resolution the same as that desktop resolution, and
said display control section displays said image on said display unit for which said display resolution has been set as the same as said desktop resolution.

7) A display apparatus, comprising:
a display apparatus main unit;
a display apparatus driver that controls display on said display apparatus main unit; and
an interface driver that makes requests for screen enlargement processing to said display apparatus driver when prescribed input is performed from outside,
wherein said display apparatus driver comprises:
a display status storage section for storing the display status of said display apparatus main unit when screen enlargement processing is requested by said interface driver;
an area setting logic for setting a prescribed area within a display area of a screen displayed by said display apparatus main unit when screen enlargement processing is requested by said interface driver; and
an enlargement processing logic for decreasing a display resolution of said display apparatus main unit, and performing enlarged display on that display apparatus main unit of the image within the area set by said area setting logic.

8) The apparatus according to claim 7, wherein said area setting logic sets a prescribed area on the basis of a pointer that is displayed on the screen of said display apparatus main unit.

9) The apparatus according to claim 8, wherein said interface driver comprises a pointer position recognition logic for recognizing the position of said pointer.

10) The apparatus according to claim 7, wherein said area setting logic allows a size of the area to be set to be selected.

11) The apparatus according to claim 7, wherein said enlargement processing logic displays the image within the area set by said area setting logic, in almost the entire area of the display area of said display apparatus main unit.

12) A display control apparatus, comprising:
a pointer position recognition logic for recognizing a position of a pointer that is displayed on a screen of a display apparatus;
an area setting logic for setting a prescribed area on the screen of said display apparatus on the basis of the position of a pointer that is recognized by said pointer position recognition logic;
an image data acquisition logic for acquiring image data of an area set by said area setting logic;
a display mode changing logic for changing a display mode of said display apparatus; and
an image display logic for displaying image data acquired by said image data acquisition logic on said display apparatus for which the display mode has been changed by said display mode changing logic.

13) The apparatus according to claim 12, further comprising a display status storage section for storing the display status of the screen that was being displayed by said display apparatus when image data acquired by said image data acquisition logic is displayed on that display apparatus by said image display logic.

14) The apparatus according to claim 12, further comprising a scrolling logic for scrolling the screen when said pointer reaches an edge of that screen displayed on said display apparatus by said image display logic.

15) A storage medium on which a program that is executed on a computer apparatus that drives a display screen is stored so that the program can be read by that computer apparatus,
wherein said program executes on said computer apparatus:
first processing that accepts input for changing the display resolution of the screen displayed on said display screen; and
second processing that displays part of the on-screen image displayed on said display screen when said first processing is executed, with the display resolution of that display screen changed.

16) A program transmission apparatus, comprising:
a storage section for storing a program to be executed on a computer apparatus; and
transmitting logic for reading said program from said storage section and transmitting that program to said computer apparatus,
wherein said program executes on said computer apparatus:
processing that, when input requesting enlargement of the image displayed on a display screen is performed, saves the desktop environment and image data of said display screen at that time, and performs enlarged display of the image within an area set in part of the display area of that display screen; and
processing that updates the saved image data when image data to be displayed on said display screen is input anew.

17) A display control method for a display apparatus that displays an image in accordance with data input from a computer apparatus main unit controlled on the basis of an operating system, comprising:
a first step of setting an area in part of the image displayed by said display apparatus when input is performed for changing the image size displayed on that display apparatus;
a second step of changing the display mode of said display apparatus without notifying said operating system; and
a third step of displaying on said display apparatus for which the display mode has been changed, the image within the area set by said first step.

18) The method according to claim 17, wherein, in said first step, the size of the area set in part of the image displayed by said display apparatus can be selected from a plurality of sizes.

19) The method according to claim 17, further comprising:
a fourth step of, when input is performed for restoring the image size displayed by said display apparatus to an original image size, restoring the display mode of that display apparatus, which was changed by said second step, to the original image size, without notifying said operating system; and
a fifth step of displaying an image on said display apparatus for which the display mode has been restored to an original display mode by said fourth step.
